(19) United States
(12) Patent Application Publication
(10) Pub. No.: US 2012/0298789 A1
(43) Pub. Date: Nov. 29, 2012

(54) Aircraft

(76) Inventor: Roni Aharon Oz, Rehovot (IL)

(21) Appl. No.: 13/480,708

(22) Filed: May 25, 2012

(30) Foreign Application Priority Data
May 26, 2011 (IL) 213180

(51) Int. Cl. B64C 15/12; B64C 27/28

(52) U.S. Cl. 244/12.4; 244/23 R

(57) ABSTRACT

An aircraft comprising a fuselage and one or more propulsion motor devices attached to the fuselage. Each of the propulsion motor devices further includes means for controlling it with regard to its thrust amplitude and orientation about two axes of rotation. Each motor device can be controlled independently of the other motors. The aircraft may further include rudder and elevation means. The aircraft includes four propulsion motor devices, each motor generally located on the perimeter of the

The present invention claims priority from this applicant's patent application in Israel, Application No. 213180 filed on 26 May 2011.

The present invention relates to an aircraft with vertical take-off or landing (VTOL) and hovering abilities, and shaped as a flying wing.

### BACKGROUND OF THE INVENTION

There is a need for a flexible aircraft or flying platform, having vertical take-off or landing (VTOL) as well as hovering abilities.

Fixed engine aircraft with jet deflection suffer from reduced efficiency.

Hovering aircraft is usually sensitive to quick, radical changes in the vessel and its environment, such as wind bursts which may threaten the aircraft's stability.

It is still more difficult to control the aircraft in adverse weather, or to achieve fast response and flexibility.

### BRIEF SUMMARY OF THE INVENTION

According to the present invention, a new type of aircraft has motors which can be aimed in a desired direction. Preferably four motors are used, each independently controlled with regard to its thrust amplitude and orientation about two axes of rotation.

Each motor preferably includes an outer shroud to increase motor's efficiency, and two propellers rotating in opposite directions, to reduce or eliminate the gyroscopic effect. This greatly improves the aircraft's flexibility and maneuverability in 6 axes (three axes of location and three of rotation).

A pair of counter-rotating propellers may be installed in one motor, or each of the two counter-rotating propellers can be installed in a separate motor.

Furthermore, by directing each motor in a desired direction, a maximal thrust can be applied in that direction, for improved efficiency and energy savings.

Use of electrical motors allows good control over the thrust magnitude, as well as silent operation and a non-polluting (green) airplane.

Further features and benefits of the present invention will become apparent to persons skilled in the art upon reading the present disclosure and the attached drawings.

### BRIEF DESCRIPTION OF THE SEVERAL VIEWS OF THE DRAWINGS

FIG. 1 illustrates an isometric view of an aircraft

FIG. 2 illustrates a top view of the aircraft

FIG. 3 illustrates a side view of the aircraft

FIGS. 4A, 4B, 4C and 4D illustrate four embodiments of the aircraft's propulsion motor

FIG. 5 illustrates a block diagram of the aircraft's control system

FIGS. 6A, 6B and 6C illustrate three embodiments of an ambiance compartment

FIG. 7 illustrates means for opening and closing the ambiance compartment.

### DETAILED DESCRIPTION OF PREFERRED EMBODIMENTS OF THE INVENTION

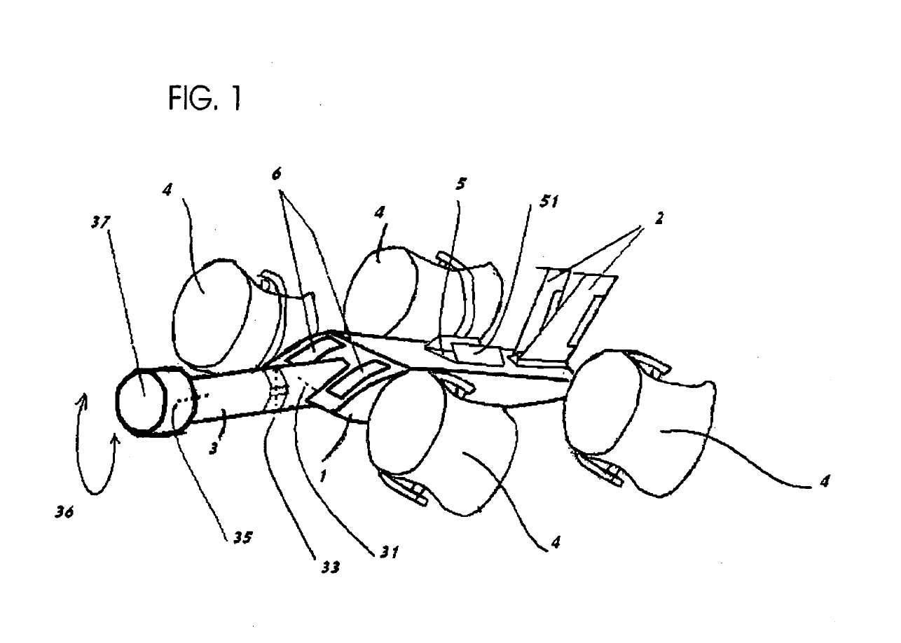

FIG. 1 illustrates an isometric view of a new aircraft, including a fuselage 1 generally shaped as a flying wing, with a tail 2 including an elevator and rudder. In a preferred embodiment, the aircraft has an extended nose 3. There are propulsion motor devices 4, each capable of exerting a thrust 49 along its longitudinal axis.

in this preferred embodiment, four motors are used. Other embodiments may use one, two or three motors installed on the fuselage 1. More than four motors may be used in other embodiments.

In any case, each of the motors is free to rotate about two axes of rotation relative to the fuselage 1, as detailed elsewhere in the present application.

An advanced flight control system achieves control of the aircraft's location, orientation and flight path by controlling the amplitude of the thrust 49 of each motor 4 at any given time, as well as the orientation in space, in two axes of rotation, of each motor 4. The motors are controlled in coordination with the rudder and elevator's angles, to achieved the desired aircraft response.

An optional feature of the present invention is an arm 3 attached to the vessel 1. The arm 3 may add several degrees of freedom to an element or device installed at its end 37. The arm 3 can rotate about three axes (31, 33, 35) and may serve for example as a water hose, camera base, and a tube transferring substances such as foam or liquids.

For instance, in hazard warfare stricken area, it is possible to trace the stricken area by unique sensors and, using the arm, rinse the polluted area, thus avoiding a risk to human forces. The system may be operated hydraulically, electro-mechanically, by snail, pneumatically, magnetically, electro-magnetic fields.

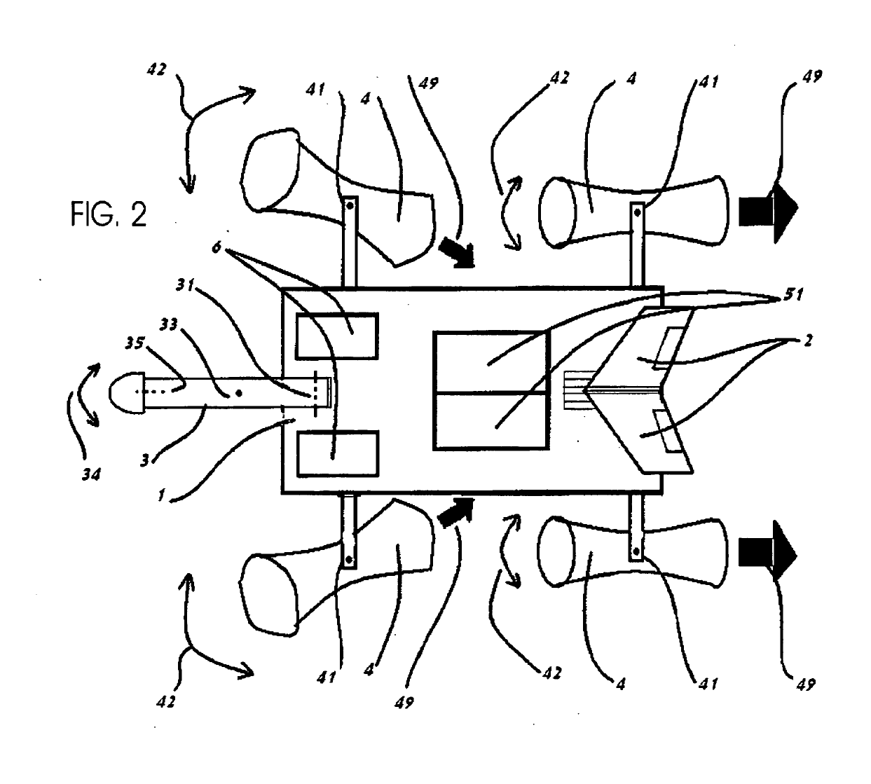

FIG. 2 illustrates a top view of the aircraft, including the fuselage 1, with access doors 6 to the interior of the fuselage and doors 51 to a compartment 5.

A tail 2 may include an elevator and rudder.

An extended nose 3 may carry various sensors and/or active systems.

There are also propulsion motor devices 4; each motor 4 is so attached to the fuselage 1 as to allow it two axes of rotation, independent of the other three motors 4.

A first axis of rotation 41 allows each motor 4 to rotate on the plane of the drawing as shown with arrows 42.

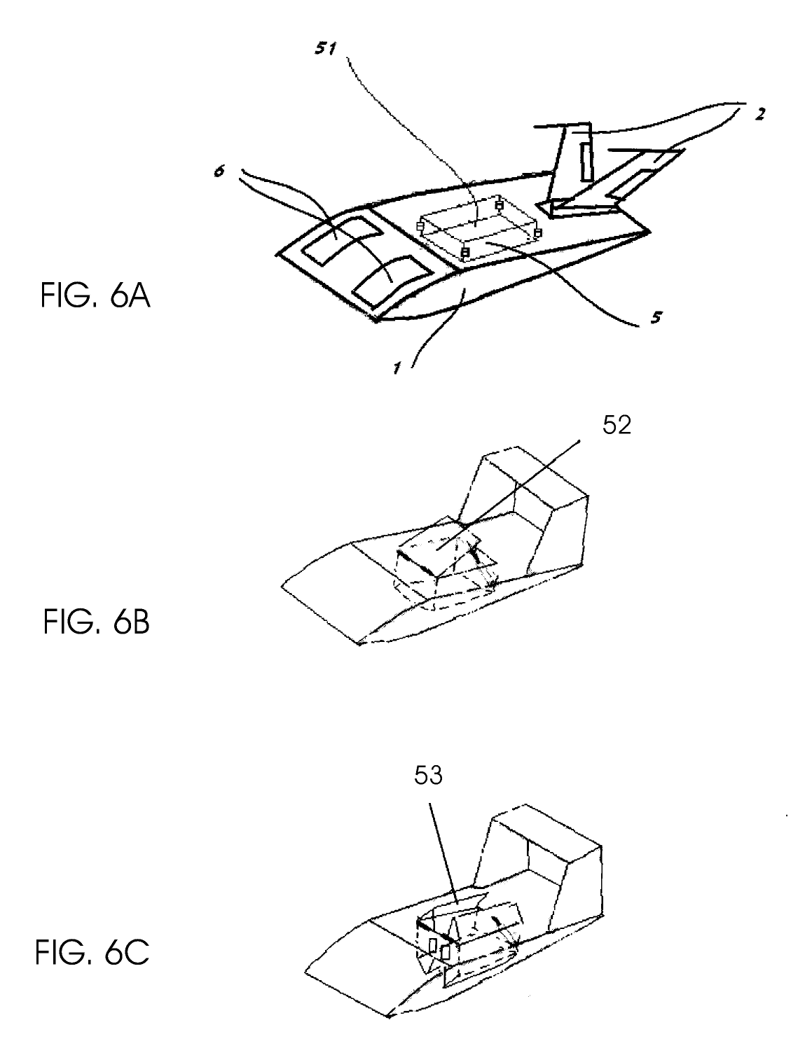

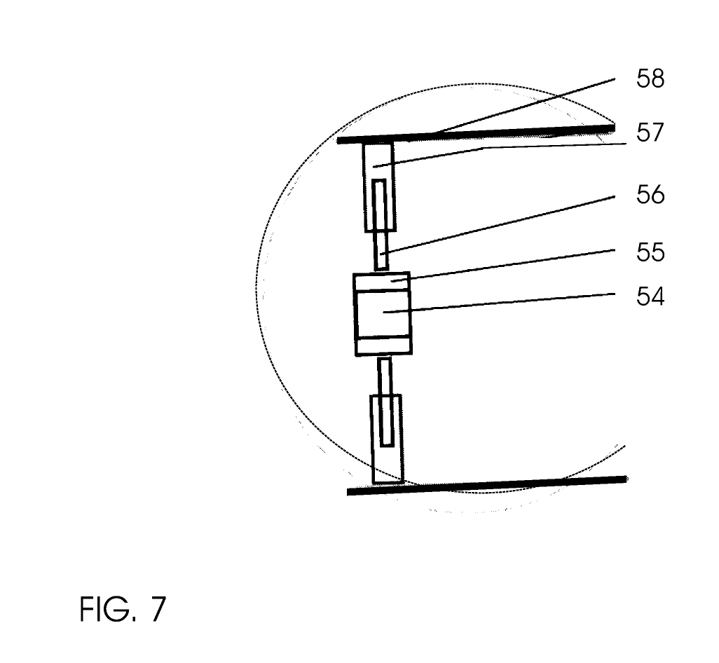

Inside the aircraft 1, there may be an ambiance compartment 5, usable for various needs in which different payloads may be transferred and operated. The compartment itself may have partial or full air isolation to adapt it to various uses. The ambiance compartment may be opened on either one side or both (51, 52, 53), according to needs. Se FIGS. 6A-6C. The opening and closing of the compartment may be performed for example (see FIG. 7) using an electric device, composed of an electric engine (54) with a planetary gear 55 on it, attached to a Ball Screw 56 and its opposite screw-nut 57 is connected to the ambiance compartment cover 58. The device can be built in different forms and it may be made of various elements such as pneumatic/hydraulic pistons, or a Ball screw.

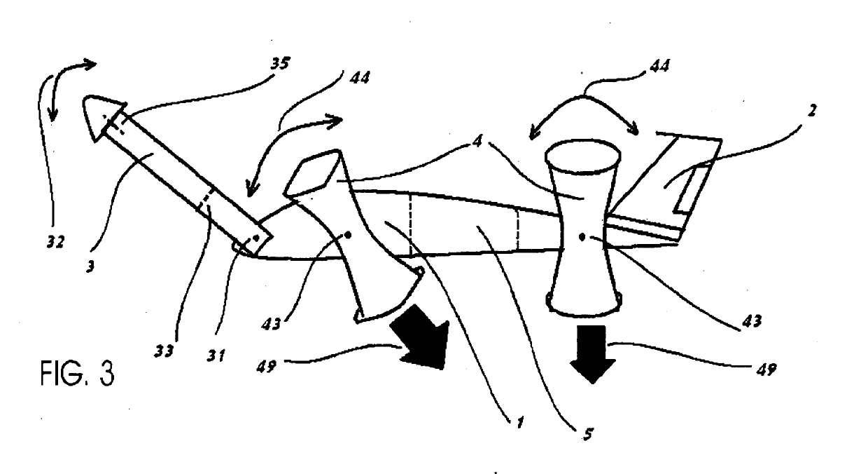

FIG. 3 illustrates a side view of the aircraft, including the fuselage 1 generally shaped as a flying wing, and a tail 2 including an elevator and rudder.

The extended nose 3 is capable of rotating in the plane of the drawing about an axis of rotation 31, as shown with arrows 32.

The aircraft further includes propulsion motor devices 4; each motor 4 is so attached to the fuselage 1 as to allow it two axes of rotation, independent of the other three motors 4.

A second axis of rotation 43 allows each motor 4 to rotate on the plane of the drawing as shown with arrows 44.

In any case, each motor may apply a thrust 49 along its longitudinal axis.

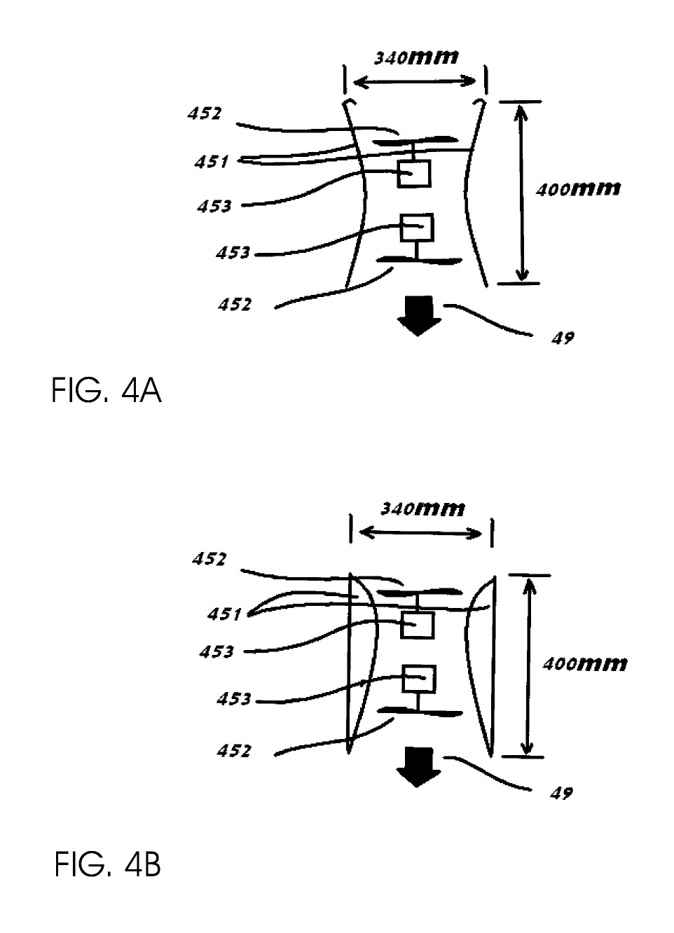

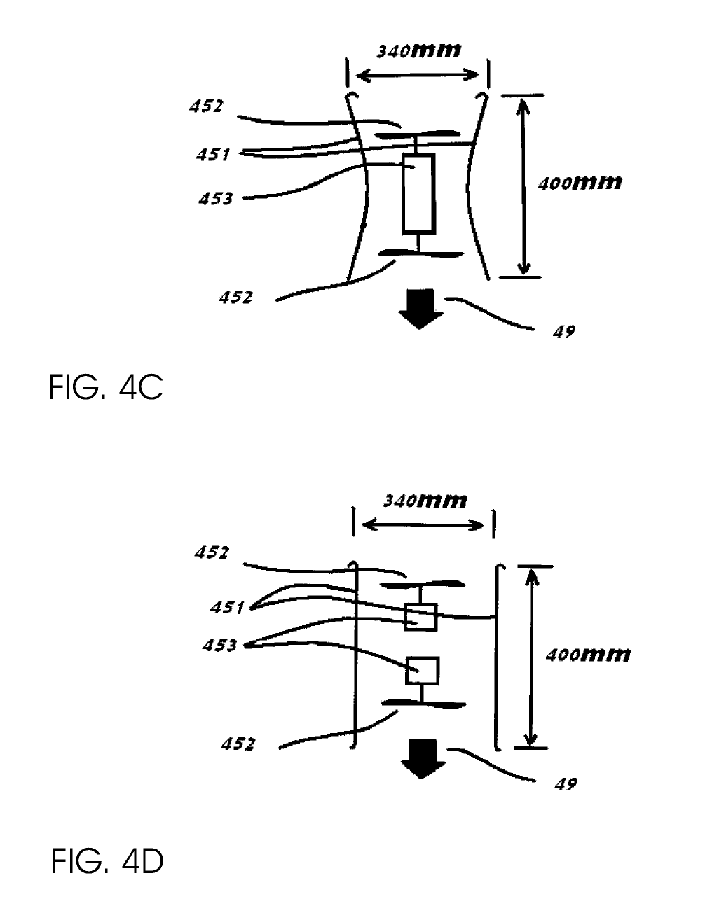

FIGS. 4A, 4B, 4C and 4D illustrate four embodiments of the aircraft's propulsion motor 4, including a shroud 451 or outer envelope and two propellers 452, rotating in opposite directions so as to eliminate or minimize any gyroscopic effect. The two propellers are so devised as to generate a thrust 49 along the axis of the motor 4.

In a preferred embodiment, the shroud 451 has a diameter 458 of about 28 centimeter (cm) and a length 459 of about 30 cm.

For larger aircraft, adequately sized motors can be used, as known in the art.

Referring to FIG. 4A, two electric motors 453 are used each to drive one propeller 452. Other embodiments may include fossil fuel motors, hydraulic or pneumatic motors, or any other type of motor.

Referring to FIG. 4B, the shroud 451 has an inner profile generally shaped like the cross-section of an aircraft wing (for example a NACA profile as known in the art), whereas in FIG. 4a the shroud 451 is generally shaped as a circular arc. In another embodiment, the shroud has an elliptic cross section.

The above shroud embodiments achieve a shroud having a smaller cross section at its interior with respect to its inlet and outlet, or at least to its inlet.

The inlet is the part of the air intake, located at the end of the motor 4 which is opposite the direction of the thrust 49.

In yet another embodiment, a cylindrical shroud structure may be used.

Referring to FIG. 4C, the two propellers 452 are driven from one common device 455, for example a motor with gear means so as to rotate the propellers 452 in opposite directions.

Referring to FIG. 4D, the shroud 457 is generally cylindrical (has a constant thickness or diameter). In a preferred embodiment, the shroud has an inlet enlarged part or phase 458.

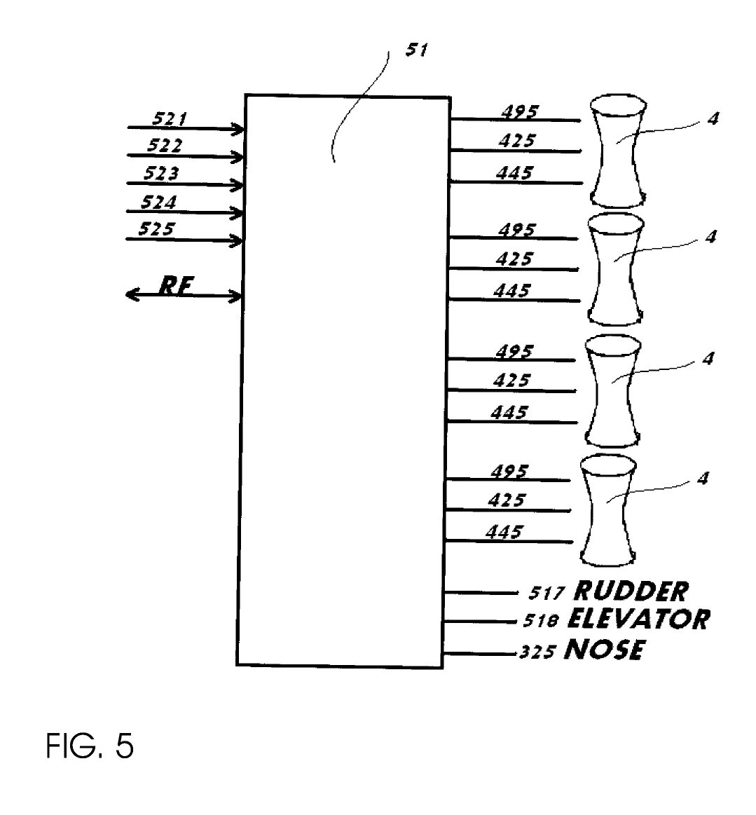

FIG. 5 illustrates a block diagram of the aircraft's control system.

An advanced flight control system achieves control of the aircraft's location, orientation and flight path.

The control system allows to place the aircraft at a desired location and orientation (in three axes of position and three axes of rotation about the location axes). This allows for example the controller of the aircraft to place the aircraft to hover in a desired location, while the aircraft can be rotated about three axes of rotation to point in a desired direction, and further the extended nose 3 can be independently rotated to point in another direction. Furthermore, the aircraft may be commanded to move along a desired path, according to a desired timetable which defines its velocity and orientation at each point.

In a preferred embodiment, the aircraft is controlled by a flight control computer 51.

For each of the motors 4, the computer 51 issues commands 495 setting the amplitude of the thrust 49 and commands 425, 445 for the orientation of the motors (for two angle variables 42, 44).

Furthermore, computer 51 controls the aircraft's rudder 517 and elevator 518 Computer 51 also issues commands 325 controlling the angle 32 of the extended nose 3.

The computer 51 can receive various inputs, for example from sensors 521, gyroscopes 522, rate gyros 523, accelerators 524, and/or GPS receiver 525 and/or from other navigation systems.

A wireless link 53 allows remote control of the aircraft, as well as sending reports of aircraft's status and any desired information.

FIGS. 6A, 6B and 6C illustrate three embodiments of an ambiance compartment 51, 52 and 53, respectively.

FIG. 7 illustrates means for opening and closing the ambiance compartment, and as detailed elsewhere in the present disclosure.

Various embodiments of the present invention will become apparent to persons skilled in the art; the present embodiments are not to limit the scope of the present invention.

1. An aircraft comprising a fuselage and one or more propulsion motor devices attached to the fuselage, wherein each of the propulsion motor devices further includes means for controlling it with regard to its thrust amplitude and orientation about two axes of rotation, and wherein each motor device can be controlled independently of the other motors.

2. The aircraft according to claim 1, further including rudder and elevation means and wherein the aircraft includes four propulsion motor devices, each motor generally located on the perimeter of the fuselage, and wherein the fuselage is generally wing-shaped.

3. The aircraft according to claim 1, further including two propellers rotating in opposite directions so as to minimize or cancel a gyroscopic effect generated by each propeller's rotation.

4. The aircraft according to claim 3, wherein each propulsion motor device further includes a shroud or envelope so devised as to enhance a propulsion efficiency generated by the propellers and motors.

5. The aircraft according to claim 1, further including a control system for controlling each of the propulsion motor devices so as to place the aircraft at a desired location, or to control an aircraft's orientation about three axes of rotation or to cause the aircraft to move along a desired path, according to a desired timetable which defines the aircraft's velocity and orientation at each point on the path.

6. The aircraft according to claim 1, further including an arm attached to the fuselage, and wherein the arm has one or more degrees of freedom to rotate about one or more axes of rotation.

7. The aircraft according to claim 6, wherein the timetable further includes parameters relating to the control of the arm.

8. The aircraft according to claim 1, further including an ambiance compartment located inside or outside of the fuselage.
